(19) United States
(12) Patent Application Publication
(10) Pub. No.: US 2011/0070423 A1
(43) Pub. Date: Mar. 24, 2011

(54) Foam and Fiber Composite Structures and Methods of Manufacture

(76) Inventors: Chandrasiri Jayakody, Saginaw, MI (US); Alison J. Kimmitz, Ashland, VA (US); Geoffrey M. Stoltz, Chester, VA (US); Chad M. Bannan, St. Charles, MI (US)

(21) Appl. No.: 12/887,943

(22) Filed: Sep. 22, 2010

Related U.S. Application Data
(60) Provisional application No. 61/245,075, filed on Sep. 23, 2009.

(51) Int. Cl. B32B 5/22; B29C 44/22

(52) U.S. Cl. 428/309.9; 264/46.5

(57) ABSTRACT

A foam-fiber composite material is provided that is made up of a monolithic foam structure having a polymer material and a fiber web having a plurality of fibers disposed substantially throughout the foam structure.

### CROSS REFERENCE TO RELATED APPLICATIONS

The present application claims the benefit of U.S. provisional application 61/245,075, filed Sep. 23, 2009, which is incorporated herein by reference in its entirety.

### FIELD OF THE INVENTION

The invention relates generally to reinforced foam structures and, more specifically, to fiber-reinforced composite materials having increased durability and utility in fields such as personal care and medical care, particularly in the area of wound care.

### BACKGROUND OF THE INVENTION

Polymeric foam materials are well-known and are found in many manifestations. Some are open-cell and some are closed-cell and either type may be hydrophobic or hydrophilic. The specific characteristics of the foam material are determined by the nature of the polymer(s) used and the process/reaction used to form the cells of the foam. Categories of foam materials include, but are not limited to, polyurethane foam, polyvinyl chloride foam, polyimide foam, silicone foam, or latex foam.

All polymeric foam structures, whether open or closed-cell, flexible or rigid, have inherent strength limitations, particularly in applications where the structure is intended for submersion in, or absorption and release of, fluids. These limitations can have a significant impact on their utility in various applications such as medical care.

Various efforts have been made to strengthen foam structures through the use of reinforcing materials. Such efforts have largely been confined to providing a backing material adhered to a surface or partially embedded within a foam structure. While these efforts may have succeeded to a degree in enhancing the overall strength of certain foam articles, their efficacy is limited due to their failure to provide reinforcement throughout the foam structure.

A different approach has been to take an existing matrix structure (e.g., a network of fibers) and embed shreds of previously formed foam material throughout the structure. The purpose of this approach is to make use of the strength properties of the matrix structure, but impart it with properties (e.g., hydrophilicity) of the foam material. In such applications, the foam material has little or no structural integrity of its own.

### SUMMARY OF THE INVENTION

An aspect of the present invention provides a foam-fiber composite material comprising a monolithic foam structure comprising a polymer material and a fiber web comprising a plurality of fibers disposed substantially throughout the foam structure.

Another aspect of the present invention provides a method of forming a foam-fiber composite material. The method comprises providing a web of fibers having a loft and a basis mass and providing a polymer foam precursor comprising a plurality of reactants. The method further comprises dispensing the polymer foam precursor onto the web of fibers and forcing penetration of the polymer foam precursor into and through the web of fibers. The method still further comprises allowing the polymer foam precursor reactants to react to form a monolithic foam structure having the plurality of fibers disposed throughout.

### DETAILED DESCRIPTION

The present invention provides composite materials comprising a continuous monolithic foam material throughout which is disposed a network or web of fibers. The fiber network may be disposed so as to provide reinforcement to the foam structure substantially through its entire extent. As will be discussed in more detail, the distribution of the fibers within the foam structure may be homogeneous or heterogeneous. In some embodiments, the fiber distribution may be systematically varied throughout the foam structure. In some embodiments, different regions within the foam structure may have different fiber distributions, each of which may be homogeneous or heterogeneous. In the alternative or in addition, the fibers within these regions may have different fiber characteristics.

The foam-fiber composite materials of the invention may be produced using a highly efficient, continuous production line. In general, the process involves mixing the polymer foam reactants and immediately depositing the mixture onto a continuous web of fibers. Before or during the foam reaction, the reactant mixture is forced into and through the fiber web. This may be accomplished using a nip roll or other doctoring tool, passage through which produces a sheet having a uniform thickness. As the reactant mixture reacts, the combined mixture/fiber web swells to form the final thickness of the composite material. By tailoring the characteristics and amount of the polymer material and the geometry of the doctoring tool to the thickness and other characteristics of the fiber web, a monolithic foam structure is formed having the fibers of the fiber web distributed throughout the structure.

The foam-fiber composites of the invention typically exhibit improved tensile strength and tear strength. They may also be structured to provide porosity or capillarity gradients through the material by the establishment of multiple cross-sectional regions having different fiber characteristics or distributions.

A significant aspect of the invention is that the continuous manufacturing process used to produce the foam-fiber composite materials of the invention allows for mass-manufacturing in an inexpensive and efficient manner. It will be understood by those of ordinary skill in the art that this process may be used to manufacture composite materials using a wide variety of foam materials and fiber webs/fabrics. However, the foam-fiber composite materials may be either hydrophobic or hydrophilic.

Because of the improved physical properties and unique manufacturing process, the foam-fiber composite material disclosed herein may be used in many applications, including long-term wound care, negative pressure wound therapy, cosmetics, and various cleaning applications. In some significant embodiments, the composite material comprises a highly absorbent foam with hydrophilic properties and that is structurally enhanced by the fibers distributed throughout the foam.

The foam-fiber composite materials of the invention will now be described in more detail. Virtually any foam material may be used to form the foam-fiber composite materials of the invention including but not limited to polyurethane, silicone foam dispersions, latex foam dispersions and other polymeric systems.

Of particular interest are composite materials in which the foam structure is a hydrophilic polyurethane foam, and many of the examples and discussions herein are directed to the use of such materials. Polyurethane foams may be either open-cell or closed-cell and may be produced via reaction of any of a variety of polyisocyanates, crosslinking agents, surfactants, and polyols, and may use a catalyst and a blowing agent or pressurized gas. Blowing agents may include water or other auxiliary blowing agents commonly used in polyurethane foam production such as acetone, liquid carbon dioxide, ethyl acetate, hydrocarbons, fluorinated hydrocarbons.

A hydrophilic, open cell polyurethane foam may be produced through a two step prepolymer-based method. The first step involves a reaction of polyisocyanate and a polyol to create a prepolymer with a stoichiometric excess of isocyanate groups. Optionally, a crosslinker can also be added to create branching, thereby improving the physical characteristics of the hydrophilic foam. The second step involves a further reaction between the prepolymer and an aqueous solution. The aqueous solution may contain surfactants, colorants, antimicrobials, vitamins, controlled release agents and other like additives discussed below. The reaction between the prepolymer and the aqueous solution produces an open-celled, hydrophilic polyurethane foam, which may be used in a variety of applications, including, but not limited to, spot pressure relieving foams for respirator masks, foams for wound care applications, cosmetic applicator foams, and the like.

Polyisocyanates useful in making prepolymers that can be used to produce foam structures for use in the invention include toluene diisocyanate (TDI) in the form of 2,4- and 2,6-isomers in the ratio of 80:20 or 65:35, diphenylmethane diisocyanate (MDI), polymeric diphenylmethane diisocyanate (PMDI), a mixture of various isomers of diphenylmethane diisocyanate, a mixture of TDI and MDI, isopherone diisocyanate (IPDI), dicyclohexylmethane-4,4′-diisocyanate (H₁₂MDI), 1,6-hexamethylene diisocyanate (HDI), polyaryl polymethylene polyisocyanate (PAPI), ethylene diisocyanate, cyclohexylene-1,2-diisocyante, cyclohexylene-1,4-diisocyanate, m-phenylene diisocyanate, 1,4-tetramethylene diisocyanate, 1,5-naphthalene diisocyanate, diphenyl-2,4,4′-triisocyanate, triphenyl)methane-4,4′,4″-triisocyanate, toluene-2,4,6-triisocyanate, trimethylene diisocyanate, xylene diisocyanate, 3,3′-dimethyl-4,4′-biphenylene diisocyante, and other aliphatic, cycloaliphatic and/or aromatic polyisocyanates.

Polyols that may be used in this invention include polyether polyols, polyester polyols (for example, polycaprolactone), polyoxyalkylene polyols (for example, polyoxyethylene polyols), oxyethylene-oxypropylene block copolymer polyols, polyols with hydroxyl functionality of two or more, mixtures of these, and the like. Other derivatives such as polyamides, polyanhydrides, polycaprolactones, polylactides may also be used. Any other polymers comprising two or more end groups with reactive hydrogen atoms (e.g. amino group, thiol, hydroxyl) may also be used.

Crosslinkers that may be used in this invention include propylene glycol, 1,2-butanediol, 1,3-butanediol, 1,4-butanediol, trimethylene glycol, trimethylolpropane, trimethylolethane, glycerol, pentaerythritol, sucrose, triethanolamine, triisopropanolamine, resorcinol, ethylene diamine, propylene diamine, catechol, and the like.

Off-the-shelf prepolymers that can be used to produce polyurethane foams in various embodiment of the invention include such products as PrePol (Filtrona Porous Technologies), HYPOL® (Dow Chemical Co.), TREPOL® (Rynel, Inc.), AQUAPOL® (Carpenter Co.), or UREPOL® (Envirochem Technologies Corp.).

The aqueous solution used to produce the foam structure of the invention may be water or an emulsion of water and surfactants. Alternatively, other aqueous emulsions that may be used include, but are not limited to, polyvinyl alcohols, vinyl acetate, polyvinyl acetates, polyvinylidene chlorides, polyvinylchloride latex, silicone emulsions including SM 2138 (from Momentive Performance Materials), polychloroprene latex, acrylonitrile, SBR latex, NBR latex, carboxylated copolymer latex, acrylic latex, and other lattices, acrylic acid ester polymers or copolymers, or other polymeric systems. The amount of aqueous solution or latex or silicone emulsion as a percentage of the prepolymer may be upwards of 500% or even higher. The latex and silicone emulsions are particularly useful in yielding viscoelastic type foams that can be incorporated into fiber composite materials. A non-aqueous solution may also be used to produce the foam structure of the invention, and may be a mixture of polyoxyalkylene polyol, a surfactant, a blowing agent, and a catalyst.

Additionally, the aqueous or non-aqueous solutions may optionally include various additives, some of which are intended to be released from, others of which are intended to remain in, the foam-fiber composite material when the material is exposed to a certain environment and/or applied to a certain substrate (e.g., as a wound care dressing). The releasable additives may be or include volatile ingredients and/or bioactive additives including, but not limited to, antimicrobials, antibiotics, vitamins such as vitamin E, silver or silver derivatives, lubricants, biologicals, pharmaceuticals, bactericides, botanicals, cosmetic ingredients, perfumes, detergents, soaps, disinfectants, solid particles, emollients, volatiles, and other like additives. The releasable additives may comprise controlled-release mechanisms or structures that serve to control the timing or duration of release of the releasable additive for interaction with another material or surface. The unreleasable additives may be or include blood clotting agents such as chitosan, flame retardants, cosmetic ingredients, colorants, waxes, superabsorbent polymers, cellulosic polymers, solid particles, and other like additives.

In some embodiments, the releasable or unreleasable additives described above may be incorporated into the foam-fiber composite material by mixing with the prepolymer component of the foam instead of or in addition to the aqueous component.

The relative amount of releasable or unreleasable additives that can be added will depend on the specific foam materials and the nature and desired use of the additive. Typically, however, the amount of the releasable or unreleasable additive will be in a range of 0.0001 percent to about 80 percent by weight of the dry foam material.

As noted above, any foam material may be used to form the composite materials of the invention. In many applications, however, it is desirable that the foam material be biodegradable. In essence, the product may be biodegradable if both components (foam and fiber) are hydrolytically unstable, and therefore would undergo degradation under aqueous conditions. Exemplary biodegradable foams that may be used in the invention may be produced by making the prepolymer with any of various degradable polyesters (i.e., instead of polyethers) and aliphatic diisocyanates such as Desmodur® W (H₁₂MDI) (instead of aromatic TDI, MDI).

Open cell hydrophilic foams made in the above manner have several advantages, including superior water absorption and purity levels. This makes them valuable for stringent medical applications. Unreinforced foams of this type do, however, have several disadvantages: they tend to swell significantly when wet, have relatively poor tensile and tear strength when dry, and have even poorer tensile and tear strength when wet. They also have a relatively homogeneous, or isotropic, pore structure, which means that they may not be configured to contain a gradient of porosity or capillarity, which would serve to move or pull liquid from one side of the foam construction to the other in a variable, but controlled, manner.

The composite materials of the invention overcome the above-described disadvantages through the incorporation of fibers throughout the foam structure. The fiber network of the foam-fiber composite materials of the invention may be or comprise virtually any woven or non-woven fiber web. The fibers themselves may be comprised of synthetic or natural polymers or may be non-polymeric. If polymeric, the fibers may be any of a variety of fiber types including extruded fibers, monocomponent fibers, multicomponent fibers, melt-blown fibers, wet-spun fibers, dry-spun fibers, bonded fibers, natural fibers, and the like. The composition of the fibers may include any thermoplastic or thermoset polymeric material, including but not limited to, cellulose acetate, other acetates and esters of cellulose, virgin or regenerated cellulose, polyamides, such as nylons, including nylon 6 and nylon 66; polyolefins, such as polyethylene and polypropylene; polyesters including polyethylene terephthalate and polybutylene terephthalate; polyvinyl chloride; polymers of ethylene methacrylic acid, ethylene acrylic acid, ethylene vinyl acetate, or ethylene methyl acrylate; polystyrene; polysulfones; polyphenylene sulfide; polyacetals; acrylics and polymers comprising blocks of polyethylene glycol; as well as copolymers and derivatives of all of the foregoing. Biodegradable polymeric materials that may be used include polycaprolactone (PCL), polyglycolide (PGA), polylactide (PLA), polyaramides, natural fibers (e.g. cotton, wool), and the like. Non-organic fibers such as carbon fibers, glass fibers and mineral fibers may also be used.

The fiber webs used in the invention may be provided in a variety of forms. For example, they may be provided in bulked or un-bulked form. Any or all of the fibers may be provided as bonded or unbonded webs of staple or continuous fibers (e.g., filaments or tows). The fiber web may be comprised in the form of a woven or non-woven fabric. In a non-woven fabric, the fibers may, in some embodiments, be thermally, chemically, or mechanically (e.g., by needle punching, hydro entanglement, embossing, and the like) bonded to one another at spaced apart points of contact. The fibers may be formed and collected using any of the methods disclosed in U.S. Pat. Nos. 5,607,766; 6,103,181; and 7,290,668 and U.S. patent application Ser. No. 11/333,499, filed Jan. 17, 2006, the disclosures of all of which are incorporated herein by reference in their entirety. In particular, they may be carded, air laid, wet laid, through-air bonded, meltblown, melt spun, spun bonded, or spunlaced to form bonded or unbonded webs.

In particular embodiments of the invention, the fiber portion of foam-fiber composite materials are provided in the form of non-woven sheets of polymeric staple fibers. Such non-woven materials have proven advantageous in the manufacturing process and in yielding improved physical properties of the final foam-fiber composite. The non-woven sheets may be made by one of a number of different methodologies and can have high loft, or thickness, or can be “flat” (i.e., have a very low loft). When formed of either hydrophilic fibers or fibers featuring a hydrophilic surface finish, non-woven textiles have absorbency properties that make them particularly suitable for certain medical applications. (Non-woven polyester rayon constructions, for example, are widely used in wound care applications as bandage media (e.g., gauze)).

The foam-fiber composite materials of the invention may be formed by a continuous manufacturing process in which a continuous fiber web provides a matrix into which an as-yet unreacted or only partially reacted polymer foam precursor is introduced. When the polymer reacts (or as it continues to react) to form the cells of the foam structure, it expands throughout the fiber matrix. As has been discussed, a goal of the method is to produce a composite in which the fiber matrix extends substantially throughout the foam material. It has been found, however, that this may be accomplished only through the use of certain criteria to match the amount and nature of the foam material to characteristics of the fiber web such as its loft, thickness, density and porosity.

In particular, for some embodiments of the invention, it has been found that the roll gap of the nip roller and the flow rate of the polymer foam precursor should be set so that the resulting thickness of the foam component is approximately equal to the initial thickness of the fiber web prior to indoctrination of the precursor into the web. This tends to assure that the fibers of the web are completely distributed throughout the foamed material in a rapid manner. In effect, the foam and fiber matrix is created upon pouring and then immediately passed through a nip roller gap. Composite materials produced in this manner exhibited improved tensile and tear strength compared to native (unreinforced) foam.

As briefly described above, the manufacturing process involves preparing a polymer foam precursor (e.g., by mixing a prepolymer with an aqueous solution) in a mix head. If any releasable or unreleasable additives are to be included they may be added to one or both of the constituents (i.e., the prepolymer or the aqueous solution) prior to combining the materials in the mix head or may be added separately into the mixture. The polymer foam precursor is then deposited onto a fiber web via a mix head. As discussed above, the fiber web may be in the form of a woven or non-woven fabric. In an exemplary embodiment, the polymer foam precursor is continuously deposited on a continuous fiber web and then passed through a doctoring device such as a nip roller to force the polymer foam precursor to penetrate and saturate the fiber matrix. Significantly, the indoctrination of the polymer foam precursor is accomplished prior to any significant expansion due to a blowing reaction. The blowing reaction itself, depending on the specific materials used, may be initiated through the mixing of the materials making up the polymer foam precursor (as is the case in the example above for the hydrophilic polyurethane foam) or through subsequent initiation of a blowing agent within the polymer foam precursor.

Using a nip roller in this manner to force the penetration and saturation of the fiber matrix, and doing so at this stage of the reaction, allows for rapid production of a foam structure with fibers distributed throughout the foam (or if desired through a portion of the foam), and a continuous foam-fiber composite material having a uniform thickness that may later be out into a desired length or shape. The gap of the nip roller may be adjusted to control the thickness of the foam-fiber composite. Different thicknesses of the foam-fiber composite may also be obtained by using fiber webs with different thicknesses and adjusting the nip roller gap to correspond to these thicknesses.

In a particular exemplary embodiment, the manufacturing process comprises dispensing the polymeric foam precursor (e.g., a hydrophilic polymerizing mixture of prepolymer and aqueous solution) onto a fiber web placed on a release liner. A second release liner is then placed over the fiber web and the polymeric foam precursor. The release liners, fiber matrix, and hydrophilic polymerizing mixture are then fed through a nip roller to force penetration of the hydrophilic polymerizing mixture into the fiber matrix. This “sandwich” approach improves the quality of the composite material and provides for easy removal of the composite at the end of the casting line. The top and bottom release liners are removed at the end of the production line when the foam-fiber composite material becomes tack free. The foam-fiber composite material may then be dried in an oven or similar device.

In typical embodiments, such as those involving a hydrophilic polyurethane foam, the fiber matrix may have a basis mass in a range of 1-500 gsm (g/m²) and, prior to combining with the polymer foam precursor, a loft, or caliper, in a range of about 0.5 to 50 mm. In these embodiments, average fiber diameter will typically be in a range of 5-100 μm. In some advantageous embodiments, the fiber matrix may have a basis mass in a range of 100-200 gsm and, prior to combining with the polymer foam precursor, a loft, or caliper, in a range of about 25 to 50 mm. In other advantageous embodiments, the fiber matrix may have a basis mass in a range of 10-125 gsm and, prior to combining with the polymer foam precursor, aloft, or caliper, in a range of about 0.5 to 6.0 mm.

In some embodiments of the invention, the fiber web or matrix may be made up of multiple fiber layers or webs arranged one on top of the other or in a side-by-side configuration. This may, for example, be a first non-woven fabric overlaid by a second non-woven fabric. The resulting multi-layer web may be used as the fiber component during a single manufacturing process to obtain a single integrally formed foam-fiber composite material. If, however, the fiber layers have different properties (e.g., basis mass, loft, density, etc.), the resulting foam-fiber composite material will be formed with a plurality of cross-sectional regions of differing characteristics. Each of these regions may have a distribution of fibers that is different from the distribution of fibers in each other region. Some or all of these regions may have homogeneous fiber distributions and each region may have different physical characteristics. In other words, the foam-fiber composite material may have multiple distinct fiber layers which are intentionally of different basis masses along the width of the foam-fiber web and therefore create intentionally different physical characteristics of the foam-fiber web along its width.

By way of example, one fiber web having a basis mass of 25 gsm may be placed along side or on top, or partially covering another fiber web having a basis mass of 75 gsm, either thermally bonded together or not bonded together, and then combined with the polymer foam precursor to obtain a gradient-type foam-fiber composite material. The portion of the foam-fiber composite material having the fiber web with a basis mass of 75 gsm will be more dense than the portion having a fiber web with a basis mass of 25 gsm, but the fibers will nevertheless be distributed throughout the entire foam component without breaking the cross-linked molecular network of the foam, thereby allowing the foam to be monolithic. The gradient nature of such a foam-fiber composite material is useful in the wound care setting because it allows for more rapid transfer of liquid exudates away from the wound via gradient capillary action.

Other parameters that may be varied from web to web in a multi-web composite include but are not limited to variations in fiber type, fiber diameter, fiber material or structure, and web or fabric structure (e.g., woven versus non-woven, bonded versus unbonded, etc). Any of these variations may be tailored to provide the desired characteristics in different cross-sectional regions of the resulting foam-fiber composite material.

Whether multiple fiber webs with different basis masses are used or not, the resultant foam-fiber composite material advantageously may have a thickness of approximately 1-50 mm for wound care or cosmetic applications. Thicker foam-fiber composite materials may be produced by using a fiber component with a higher loft and by applying additional polymer foam precursor, and setting the nip roller to have a larger roll gap. However, a range of 1-50 mm has been found to be advantageous in wound care applications. Foam-fiber composite materials having a thickness from 20-40 mm are particularly useful in negative pressure wound therapy applications because of their increased strength.

Hydrophilic foam-fiber composite materials having the structure described above are well suited for wound care applications because they allow for rapid transfer of liquid exudates away from the wound via gradient capillarity. This promotes more rapid healing and reduces maceration of healthy skin surrounding the wound. One or more surfaces of the composite material may also be coated with silicone or glycerin coatings, which can reduce sticking to the wound and therefore reduce pain and damage during changing of wound dressings.

As noted above, releasable and/or unreleasable additives may be incorporated into the foam structure, and the releasable additives may be later released when the foam-fiber composite material is exposed to a particular environment (e.g., immersion in a fluid) or applied to a surface (e.g., application to the skin as a bandage).

Various foam-fiber composite materials according to embodiments of the invention have been produced and have demonstrated improved tensile strength, tear strength, and swelling properties over unreinforced foam materials. The composite materials produced have included structures with preordained gradient porosity or capillarity, and have been shown to be manufacturable in an inexpensive and efficient manner.

### Example 1

Table 1 lists the physical characteristics of a hydrophilic polyurethane foam-fiber composite materials prepared in accordance with one exemplary embodiment of the invention. A hydrophilic prepolymer (specifically, PrePol)/aqueous solution mixture was poured onto a 2 mm thick non-woven fiber having a basis mass of 25 gsm. The thickness of the final composite was controlled by making adjustments to the gap height of the nip roller. In this Example, the nip roller gap height was set to about 2 mm. The fiber matrix (fiber component) of the resulting composite material was distributed throughout the entire foam component and was distributed substantially homogeneously throughout the foam. The foam-fiber composite material was then subjected to a drying process to remove excess water. A comparison was made with a 2.5 mm thick hydrophilic foam and the results are summarized in Table 1.

TABLE 1
Physical characteristics of hydrophilic foam-fiber composite material
made from 25 gsm fiber matrix compared to unreinforced hydrophilic
foam.

| | | | | | Unreinforced | |
|---|---|---|---|---|---|---|
| | Fiber-reinforced Foam | | | | Hydrophilic | |
| | TD* | MD* | TD | MD | Foam | |
| | (Dry) | (Dry) | (Wet) | (Wet) | (Dry) | (Wet) |
| Thickness (mm) | 2.1 | 2.1 | 2.6 | 2.6 | 2.5 | 3.9 |
| Nominal | — | 158 | — | — | 98.0 | — |
| Density (kg/m³) | | | | | | |
| Tensile Strength | 848 | 3,309 | 234 | 2,261 | 489 | 96 |
| (kPa) | | | | | | |
| Elongation (%) | 144 | 34 | 96 | 36 | 148 | 109 |
| Tear Strength | 7932 | 6328 | 3806 | 4616 | 789 | 144 |
| (N/m) | | | | | | |

*MD = Machine Direction of the fiber; TD = Transverse Direction (i.e., Transverse to Machine Direction)

As shown in Table 1, a dry hydrophilic foam-fiber composite material according to a first exemplary embodiment of the invention showed a 73% increase in tensile strength in a direction transverse to the machine direction (i.e., the direction along which the materials are drawn as the composite material is produced) and a 905% increase in tear strength in the same transverse direction compared to a dry unreinforced hydrophilic foam of approximately the same thickness. Further, these significant improvements in tensile and tear strength were achieved while maintaining approximately the same elongation characteristics in the same transverse direction.

As also shown in Table 1, the foam-fiber composite materials exhibit different tensile and elongation characteristics when tested across the web (transverse direction) than when tested along the web (machine direction). This is in contrast to the unreinforced foam specimen which does not show significant difference in machine direction and transverse direction results due to uniform cell structure of the foam. Dry foam-fiber composites tested in a transverse direction showed lower tensile and higher elongation values compared to similar samples tested in a machine direction. This, however, is a function of the particular fiber material used in this example and does not exemplify results for all other non-woven or woven structures, which may have comparable results for both the transverse and machine directions.

Strength improvement over the unreinforced foam is even more dramatic when the results for wet specimens are compared. For example, transverse tensile and tear strength values of wet fiber reinforced specimens showed improvements of 143% and 2543%, respectively, over wet non-reinforced foam materials. The improvements in wet tensile and tear strength in the machine direction were 2255% and 3106%, respectively. Wet tear strength is a very important characteristic that one must consider when designing a wound dressing material. Wound dressing materials with poor wet tear strength may be difficult to remove when changing a wound dressing because of tearing and breakage, and may cause pain and skin damage. The foam-fiber composite material of Example 1 shows a 382-485% increase in tear strength even when wet, compared to a dry unreinforced hydrophilic foam of similar thickness, and a 2543%-3106% increase in tear strength even wet, compared to a wet unreinforced hydrophilic foam.

Ultimately, the foam-fiber composite material according to Example 1 shows significant improvements in tensile strength and tear strength even when wet while maintaining adequate hydrophilic characteristics such that it may be advantageously used in wound dressing, medical, cosmetic and other applications where natural hydrophilic characteristics coupled with higher strength are required. For example, resulting foam-fiber composite materials can be used as a cleaning pad with or without antimicrobial agents, alone or attached to a substrate, to apply water based, water emulsion based, and oil based treatments such as would be useful in sanitizing or disinfecting applications.

### Example 2

Table 2 lists the physical characteristics of a hydrophilic foam-fiber composite material prepared in accordance with another exemplary embodiment of the invention. In this example, three fiber layers (webs) were bonded together to yield a multi-web fiber matrix, which was then combined with a polymer foam precursor. The fiber matrix comprised two webs each having a basis mass of 25 gsm and one web having a basis mass of 75 gsm. The three webs were bonded together using a thermal bonding process to form a single web having an overall thickness of approximately 5 mm and an ultimate basis mass of 125 gsm (25+25+75). The combined multi-layer web was placed on a lower release liner (with the 75 gsm portion of the bonded webs adjacent the lower release liner) then passed beneath a mix head from which a polymer foam precursor (polymerizing mixture of PrePol prepolymer and aqueous solution) were dispensed. The same procedure described above in Example 1 was used to dispense the polymer foam precursor onto the fiber web. The nip roller was set to about 5 mm which resulted in a final foam-fiber composite material having a thickness of approximately 5 mm. The fiber matrix (fiber component) was distributed throughout the foam component such that there existed a predetermined variable distribution of the fibers and a gradient density through the thickness of the composite material. A comparison was made with a 5 mm thick hydrophilic foam and the results are summarized in Table 2.

TABLE 2
Physical characteristics of hydrophilic foam-fiber composite
material made from two 25 gsm fiber webs and one 75 gsm
fiber web with nip roller setting of about 5 mm.

| | Fiber-reinforced | | Unreinforced Hydrophilic |
|---|---|---|---|
| | Foam (Dry) | | Foam (Dry) |
| Thickness (mm) | 5.1 | | 5.0 |
| Nominal Density (kg/m³) | 127 | | 93.2 |
| Tensile Strength (kPa) | 2,440 | (MD) | 365 |
| Elongation (%) | 42 | (MD) | 176 |
| Tear Strength (N/m) | 4028 | (MD) | 716 |

Table 2 shows data from Example 2 tested in the machine direction (MD). As shown in Table 2, the foam-fiber composite material according to Example 2 exhibits the same trends as seen in Example 1. The foam-fiber composite material showed a 568% increase in tensile strength and a 463% increase in tear strength (machine direction) compared to the dry unreinforced hydrophilic foam of approximately the same thickness. Thus, the physical properties that are critical for wound care applications (tensile and tear strength) were far superior to those for the unreinforced hydrophilic foam of approximately the same thickness.

### Examples 3-7

Table 3 lists the physical properties of hydrophilic foam-fiber composite materials prepared in accordance with other exemplary embodiments of the invention. In these examples, multiple fiber layers were bonded together and a hydrophilic polymer foam precursor was poured onto the bonded fiber, and run through a nip roller to achieve a consistent thickness. Each example has an approximate average thickness of 5 mm, and is compared to an unreinforced hydrophilic foam material of approximately 5 mm. Each fiber layer had a basis mass of either 25 gsm or 75 gsm and a loft ranging from 1-15 mm. In each case, the plurality of fiber webs were bonded together to yield a single fiber web/matrix and, at the same time, produce the desired loft before the polymerizing mixture of prepolymer and aqueous solution was dispensed onto it. A predetermined variable distribution of fibers throughout the foam was achieved by bonding together fiber layers having a different basis mass (e.g., 25 gsm and 75 gsm).

TABLE 3
Physical properties of dry hydrophilic foam-fiber composite materials
prepared using bonded multilayer fiber webs.

| | EXAMPLE: | | | | | |
|---|---|---|---|---|---|---|
| | 3 | 4 | 5 | 6 | 7 | Control |
| Fiber-reinforced | 2 Layers | 2 Layers | 3 Layers | 1 Layer | 2 Layers | Unreinforced |
| Foam: | of 25 | of 75 | of 75 | of 25 | of 25 | Hydrophilic |
| | gsm | gsm | gsm | gsm | gsm | Foam |
| | | | | 2 layers | 2 layers | |
| | | | | of 75 | of 75 | |
| | | | | gsm | gsm | |
| Avg. Thickness | 4.21 | 5.38 | 5.86 | 5.03 | 5.89 | 5.03 |
| (mm) | | | | | | |
| Avg. Density | 96.2 | 124.3 | 146.2 | 135.0 | 158.9 | 93.2 |
| (kg/m³) | | | | | | |
| Elongation (%) | 56 (MD) | 47 (MD) | 40 (MD) | 46 (MD) | 42 (MD) | 176 |
| Tensile (kPa) | 1,310 (MD) | 2,468 (MD) | 3,350 (MD) | 2,130 (MD) | 3,095 (MD) | 365 |
| Tear Strength | 2509 (MD) | 3995 (MD) | 4993 (MD) | 3855 (MD) | 5641 (MD) | 716 |
| (N/m) | | | | | | |

As shown in Table 3, the tensile strength and tear strength of Examples 3-7 are significantly higher than those of the unreinforced hydrophilic foam. Further, foam-fiber composite materials having fiber webs with a basis mass of 75 gsm show greater tensile and tear strength properties than those having fiber webs with a basis mass of 25 gsm.

### Example 8

Table 4 lists the physical properties of a hydrophilic foam-fiber composite material according to yet another exemplary embodiment of the invention. In this embodiment, a hydrophilic polyurethane foam-fiber composite material was prepared as above but with a thicker fiber matrix such as may be used for negative pressure wound therapy (NPWT) applications. The foam-fiber composite material in this example was prepared by dispensing a mixture of prepolymer and aqueous solution onto a rolled fiber matrix of approximately 50 mm thickness, and then fed through a nip roller having a roll gap of approximately 25 mm. The foam-fiber composite material was sandwiched between two release liners as described above. The two release liners were removed at the end of the production line and the foam-fiber composite material was dried in an oven to remove excess water.

TABLE 4
Physical characteristics of hydrophilic polyurethane foam-fiber
composite material prepared with thick open matrix fiber webs

| | | | | | Unreinforced | |
|---|---|---|---|---|---|---|
| | Fiber-reinforced Foam | | | | Hydrophilic | |
| | MD | TD | MD | TD | Foam | |
| Example | (Dry) | (Dry) | (Wet) | (Wet) | (Dry) | (Wet) |
| Thickness (mm) | 19.7 | 18.3 | 23.3 | 23.3 | 25.4 | 27.4 |
| Nominal Density | | 105.2 | | | 116.7 | |
| (kg/m³) | | | | | | |
| Tensile Strength | 296 | 255 | 96 | 82 | 296 | 46 |
| (kPa) | | | | | | |
| Elongation (%) | 96 | 107 | 70 | 79 | 396 | 166 |
| Tear Strength (N/m) | 1861 | 1641 | 708 | 581 | 837 | 98 |

As is evident from Table 4, the foam-fiber composite material according to this exemplary embodiment of the invention shows much greater tear strength for the dry foam-fiber composite material than the unreinforced dry hydrophilic foam in both the transverse and machine directions of the fiber web while maintaining similar absorbent characteristics. The tensile and tear strength values of wet fiber reinforced specimens were increased by 78% and 493% respectively in the transverse direction compared to wet unreinforced foam materials. The improvements in machine direction were 109% and 622% respectively.

It will be understood that a thicker foam-fiber composite material is useful in negative pressure wound therapy applications because it is able to withstand forces inherent in such applications where a controlled sub-atmospheric or negative pressure is applied to the wound bed with a tube threaded through the dressing via a vacuum source to promote the moist wound healing process of acute or chronic wounds.

### Example 9

Examples 9A-E are foam-fiber composite materials according to additional embodiments of the invention. These embodiments comprise latex and other emulsions to produce the foam component of the foam-fiber composite materials. These emulsions and their loading level in the aqueous solution are shown in the Table 5. These aqueous emulsion solutions were mixed with PrePol prepolymer and MDI based prepolymers and poured onto thin fiber webs to obtain foam-fiber composite materials.

TABLE 5
Various latex and other emulsions used as the aqueous
solutions to make foam-fiber composite materials

| | | Pluronic ® | Deionized |
|---|---|---|---|
| | Emulsion | L62 | Water |
| Example 9A | Ucar ® Latex 455 95% | 5% | — |
| Example 9B | Fulatex ® PVA Emulsion PD- | 5% | — |
| | 0330 95% | | |
| Example 9C | Sytrene Butadiene Rubber | 5% | 70% |
| | (SBR) Latex 25% | | |
| Example 9D | Fulatex ® PD 0233 Emulsion | 5% | 70% |
| | 25% | | |
| Example 9E | Silicone Emulsion SM2138 | 5% | |
| | 95% | | |

*The non-volatile solid content of the above emulsions may be in the range of 20-70 wt %.

Products made from the foam-fiber composites described above have utility in a number of applications, including, but not limited to, dressings for wound care, cosmetic, household cleaning/disinfecting applications. One advantage of the medical grade foam-fiber composite materials is the rapid transfer of exudate fluids away from the wound to facilitate healing of wounds, especially wound tunnel and deep wound cavity treatments and chronic wounds that may be a byproduct of diabetes and burns. The foam-fiber composite materials described herein have further utility in that they are substantially clean as a result of their resistance to shedding debris, allow for dressing changes without the pain of sticking to the wound surface, and reduce maceration of good skin in the area surrounding the wound.

It will be readily understood by those skilled in the art that the present invention is susceptible to broad utility and application. Many embodiments and adaptations of the present invention other than those herein described, as well as many variations (for example, foam being hydrophilic or hydrophobic), modifications and equivalent arrangements, will be apparent from or reasonably suggested by the present invention and foregoing description thereof, without departing from the substance or scope of the invention.

While the foregoing illustrates and describes exemplary embodiments of this invention, it is to be understood that the invention is not limited to the construction disclosed herein. The invention can be embodied in other specific forms without departing from its spirit or essential attributes.

What is claimed is:

1. A foam-fiber composite material comprising:
a monolithic foam structure comprising a polymer material; and
a fiber web comprising a plurality of fibers disposed substantially throughout the foam structure.

2. A foam-fiber composite material according to claim 1, wherein the fibers are distributed homogeneously throughout the foam structure.

3. A foam-fiber composite material according to claim 1, wherein the foam structure comprises a plurality of cross-sectional regions, each having a portion of the fibers disposed homogeneously therein.

4. A foam-fiber composite material according to claim 1, wherein the fibers are disposed so as to provide a predetermined variable distribution of fibers within the foam structure.

5. A foam-fiber composite material according to claim 1, wherein the foam structure comprises a polymer selected from the set consisting of a hydrophobic polymer material and a hydrophilic polymer material that is a product of a reaction between at least one prepolymer and an aqueous solution.

6. A foam-fiber composite material according to claim 5, wherein the aqueous solution is an emulsion selected from the set consisting of a latex emulsion and a silicone emulsion.

7. A foam-fiber composite material according to claim 5, wherein the prepolymer comprises at least one polyisocyanate of the set consisting of an aromatic polyisocyanate, an aliphatic polyisocyanate, and a cycloaliphatic polyisocyanate.

8. A foam-fiber composite material according to claim 5, wherein the prepolymer comprises an isocyanate selected from the set consisting of diphenylmethane diisocyanate (MDI) and toluene diisocyanate (TDI).

9. A foam-fiber composite material according to claim 1, wherein the polymer material is a polyurethane.

10. A foam-fiber composite material according to claim 1, wherein the polymer material is selected from the set consisting of a silicone and a latex.

11. A foam-fiber composite material according to claim 1, wherein the foam structure further comprises at least one releasable additive adapted for release and application to a surface contacted by the foam-fiber composite material, the at least one releasable additive selected from the group consisting of antimicrobials, antibiotics, vitamins, sliver, lubricants, biologicals, pharmaceuticals, bactericides, botanicals, cosmetic ingredients, perfumes, detergents, soaps, disinfectants, emollients, volatile compounds, and any combination thereof.

12. A foam-fiber composite material according to claim 1, wherein the foam structure further comprises at least one unreleasable additive selected from the group consisting of blood clotting agents, flame retardants, cosmetic ingredients, colorants, waxes, superabsorbent polymers, cellulosic polymers, solid particles, and any combination thereof.

13. A foam-fiber composite material according to claim 1, wherein the plurality of fibers includes at least one of the set consisting of polymeric fibers, natural fibers, carbon fibers, glass fibers, mineral fibers and metal fibers.

14. A foam-fiber composite material according to claim 1, wherein at least a portion of the plurality of fibers have a hydrophilic surface.

15. A foam-fiber composite material according to claim 1, wherein the plurality of fibers are comprised of a polyolefin polymer.

16. A foam-fiber composite material according to claim 1, wherein the fiber web comprises at least one of the set consisting of a woven fabric, a non-woven fabric, and a self-sustaining bonded fiber structure.

17. A foam-fiber composite material according to claim 1 having a thickness in a range of about 1 mm to about 50 mm.

18. A foam-fiber composite material according to claim 1 having a thickness in a range of about 2 mm to about 6 mm.

19. A foam-fiber composite material according to claim 1, wherein the foam-fiber composite material is configured for use as one of the set consisting of a wound care dressing, a negative pressure wound therapy dressing, an antimicrobial pad, a drug delivery device, a cosmetic pad, a cleaning pad, and a hemostatic wound dressing.

20. A method of forming a foam-fiber composite material comprising:
providing a web of fibers having a loft and a basis mass;
providing a polymer foam precursor comprising a plurality of reactants;
dispensing the polymer foam precursor onto the web of fibers;
forcing penetration of the polymer foam precursor into and through the web of fibers; and
allowing the polymer foam precursor reactants to react to form a monolithic foam structure having the plurality of fibers disposed throughout.

21. A method of forming a foam-fiber composite material according to claim 20, wherein the action of forcing penetration includes:
passing the plurality of fibers and the foam reactants through a nip roller gap.

22. A method of forming a foam-fiber composite material according to claim 21, wherein a height of the nip roller gap is established so as to assure distribution of the plurality of fibers throughout the monolithic foam structure.

23. A method of forming a foam-fiber composite material according to claim 20, wherein the web of fibers comprises a plurality of fiber web layers, each having different physical characteristics.

24. A method of forming a foam-fiber composite material according to claim 23, wherein each fiber web layer comprises different fiber materials.

25. A method of forming a foam-fiber composite material according to claim 20, wherein the actions of dispensing and forcing penetration are carried out prior to any significant reaction of the polymer foam precursor reactants.

26. A method of forming a foam-fiber composite material according to claim 20 wherein the polymer foam precursor reactants comprise a polyurethane prepolymer and an aqueous solution.

27. A method of forming a foam-fiber composite material according to claim 20, wherein the polymer foam precursor reactants comprise at least one polyisocyanate of the set consisting of an aromatic polyisocyanate, an aliphatic polyisocyanate, and a cycloaliphatic polyisocyanate.

28. A method of forming a foam-fiber composite material according to claim 20, wherein the monolithic foam structure comprises one of the set consisting of a polyurethane, a silicone polymer, and a latex polymer.

29. A method of forming a foam-fiber composite material according to claim 20, further comprising:
adding at least one releasable additive to one of the foam reactants, the at least one releasable additive being adapted for release and application to a surface contacted by the monolithic foam structure.

30. A method of forming a foam-fiber composite material according to claim 29, wherein the at least one releasable additive is selected from the group consisting of antimicrobials, antibiotics, vitamins, sliver, lubricants, biologicals, pharmaceuticals, bactericides, botanicals, cosmetic ingredients, perfumes, detergents, soaps, disinfectants, emollients, volatile compounds, and any combination thereof.

31. A method of forming a foam-fiber composite material according to claim 20, further comprising:
adding at least one unreleasable additive selected from the group consisting of blood clotting agents, flame retardants, cosmetic ingredients, colorants, waxes, superabsorbent polymers, cellulosic polymers, solid particles, and any combination thereof.
